(19) United States
(12) Patent Application Publication
(10) Pub. No.: US 2011/0187752 A1
(43) Pub. Date: Aug. 4, 2011

(54) BACKLIGHT CONTROL APPARATUS AND CONTROL METHOD THEREOF

(75) Inventors: Chung-Jian Li, Hsinchu County (TW); Tzung-Yuan Lee, Taichung County (TW); Ching-Chun Lin, Taipei County (TW)

(73) Assignee: NOVATEK MICROELECTRONICS CORP., Hsinchu (TW)

(21) Appl. No.: 12/957,412

(22) Filed: Dec. 1, 2010

(30) Foreign Application Priority Data
Feb. 3, 2010 (TW) 99103189

(51) Int. Cl. G09G 5/10

(52) U.S. Cl. 345/690

(57) ABSTRACT

A backlight control apparatus is for controlling the luminance of a backlight panel. The backlight control apparatus includes an image analyzer and a mode switch, wherein the image analyzer receives a present frame information and a previous frame information, and compares the received frame information with each other and obtains a variation between the present frame information and the previous frame information. The mode switch receives the variation and sets a displaying mode for adjusting the luminance of the backlight panel according to the variation.

### CROSS-REFERENCE TO RELATED APPLICATION

This application claims the priority benefit of Taiwan application serial no. 99103189, filed on Feb. 3, 2010. The entirety of the above-mentioned patent application is hereby incorporated by reference herein and made a part of this specification.

### BACKGROUND OF THE INVENTION

1. Field of the Invention

The present invention generally relates to a backlight control apparatus and the control method thereof, and more particularly, to a control apparatus and a control method of a backlight panel of a display panel.

2. Description of Related Art

In a display apparatus with passively light-emitting (for example, a liquid crystal display apparatus, i.e., LCD apparatus), it's a well known technique to deploy a backlight panel serving as the light-emitting source thereof. Along with the durably increasing demand of users on the display quality of a display apparatus, now the backlight panel is not a mean to provide a pure light source only. In fact, the luminance of a modern backlight panel needs to be adjusted depending on different display conditions and the electrical consumption, so that the efficiency of the display apparatus can be effectively advanced.

In this regard, a recently lunched content adaptive backlight control (CABC) technique is a technical effort, where the content of displayed image is used to adjust the luminance of backlight panel. The CABC technique is used to correspondingly adjust the luminance of backlight panel according to different frame modes of a display apparatus, i.e., according to a static frame mode or a dynamic frame mode. Adopting the CABC scheme makes a display apparatus have the optimal display effect under the most effective power management to achieve the minimum power consumption. However, in the conventional CABC embodiments, during switching the luminance of backlight panel, due to an incorrect switching time-point, the displayed frame of the display apparatus produces flashing phenomena so as to downgrade the display quality.

### SUMMARY OF THE INVENTION

Accordingly, the present invention is directed to a backlight control apparatus and the control method thereof for automatically detecting a display panel for static display or animated display and thereby adjusting the luminance of backlight panel.

The present invention provides a backlight control apparatus for controlling the luminance of backlight panel. The backlight control apparatus includes an image analyzer and a mode switch, wherein the image analyzer receives a present frame information and a previous frame information, and compares the received frame information with each other and obtains a variation between the present frame information and the previous frame information. The mode switch is coupled to the image analyzer for receiving the variation and setting a displaying mode for adjusting the luminance of backlight panel according to the variation.

In an embodiment of the present invention, the above-mentioned image analyzer obtains the variation according to the differences of the gray levels of a plurality of pixels corresponding to a same display position between the present frame information and the previous frame information.

In an embodiment of the present invention, the above-mentioned mode switch compares the variation with a threshold value. When the variation is greater than the threshold value, the mode switch sets the displaying mode as an animated mode; when the variation is not greater than the threshold value, the mode switch sets the displaying mode as a static mode.

In an embodiment of the present invention, when the above-mentioned displaying mode is the animated mode, the luminance of backlight panel is accordingly adjusted down; when the displaying mode is the static mode, the luminance of backlight panel is adjusted up.

In an embodiment of the present invention, the above-mentioned backlight control apparatus further includes a memory. The memory is coupled to the image analyzer for receiving and storing the previous frame information.

The present invention further provides a backlight control method for controlling luminance of backlight panel. The method includes: receiving a present frame information and a previous frame information; comparing the received information with each other and obtaining the variation between the present frame information and the previous frame information; setting the displaying mode for adjusting the luminance of backlight panel according to the variation.

Based on the depiction above, the present invention obtains the difference between two successive frame information according to the variation between the present frame information and the previous frame information to be displayed and further obtains the displaying mode for the display to conduct an animated frame displaying or a static frame displaying. In this way, the present invention can effectively avoid the display from producing flashing phenomena during switching the displaying mode and advance the display quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a backlight control apparatus 100 according to an embodiment of the present invention.

FIG. 2 is a diagram showing the calculation method of the variation according to an embodiment of the present invention.

FIG. 3 is a flowchart of a backlight control method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

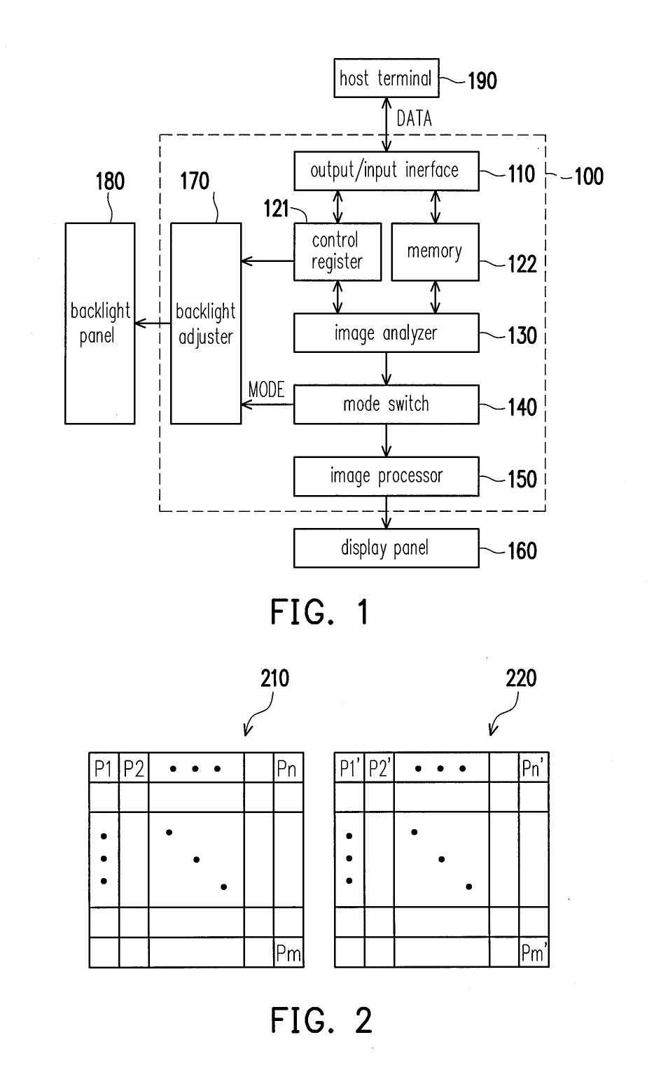

FIG. 1 is a diagram of a backlight control apparatus 100 according to an embodiment of the present invention. Referring to FIG. 1, the backlight control apparatus 100 is for controlling the luminance of a backlight panel 180 and includes an output/input interface 110, a control register 121, a memory 122, an image analyzer 130, a mode switch 140, an image processor 150 and a backlight adjuster 170. The output/input interface 110 herein receives information DATA come from a host terminal 190 and transmits the information DATA respectively to the control register 121 and the memory 122. The information DATA come from the host terminal 190 usually includes an image display data provided to the display panel 160 and a command data for controlling the operation of the backlight control apparatus 100, wherein the image display data is transmitted to the memory 122 for storing and the command data is transmitted to the control register 121 for registering.

The output/input interface 110 also provides the host terminal 190 with reading out the values stored in the control register 121 or the memory 122, which anyone skilled in the art knows and is omitted to describe.

The image analyzer 130 is coupled to the control register 121 and the memory 122. The image analyzer 130 receives the present frame information and the previous frame information to be processed, wherein when the capacity of the memory 122 is large enough, both the previous frame information and the present frame information can be successively saved in the memory 122, and then, the image analyzer 130 reads out the previous frame information and the present frame information from the memory 122 for processing; when the capacity of the memory 122 is smaller, the memory 122 stores the previous frame information only, and then, when the host terminal 190 sends out the present frame information, the image analyzer 130 reads out the previous frame information from the memory 122 and the instantaneously transmitted present frame information for processing.

The image analyzer 130 compares the present frame information with the previous frame information to judge the variation between the two successive frame information. The image analyzer 130 conducts subtracting operation on the gray levels of a plurality of pixels corresponding to a same display position in the display panel 160 between the present frame information and the previous frame information so as to obtain a plurality of differences of the gray levels. FIG. 2 is a diagram showing the calculation method of the variation according to an embodiment of the present invention. Referring to FIG. 2, the gray levels of a plurality of pixels in the previous frame information 210 are P1-Pm and the gray levels of a plurality of pixels in the present frame information are P1′-Pm′. The image analyzer 130 respectively calculates the difference between the gray level P1′ and the gray level P1, the gray level P2′ and the gray level P2 . . . the gray level Pn′ and the gray level Pn . . . the gray level Pm′ and the gray level Pm so as to obtain m differences of the gray levels (wherein m and n are positive integers and m>n). The variation can include the differences of the gray levels or the summation of differences of the gray levels. In addition, P1-Pm can be respectively a gray level of individual pixel or an average of gray levels of a plurality of pixels of a pixel block composed of the plurality of pixels.

The variation can be also a result of processing the gray level histograms. That is to say, the image analyzer 130 firstly builds two gray level histograms, one is the gray level histogram of all the pixels of the previous frame information and another is the gray level histogram of all the pixels of the present frame information. Then, the image analyzer 130 compares the two gray level histograms with each other and calculates the variation between the gray level histogram of the present frame information and the gray level histogram of the previous frame information and thereby judge whether or not the variation between the present frame information and the previous frame information is excessive.

Continuing to FIG. 1, the mode switch 140 is coupled to the image analyzer 130 and receives the variation produced by the image analyzer 130, followed by comparing the variation with a threshold value so as to judge whether the image displayed by the display panel 160 is a static image or a dynamic image. In short, when the variation is the summation of all the differences of the gray levels, only the variation needs to be compared with the threshold value. When the variation is greater than the threshold value, the image displayed by the display panel 160 is judged as a dynamic image; when the variation is not greater than the threshold value, the image displayed by the display panel 160 is judged as a static image. If the variation includes a plurality of differences of the gray levels, the mode switch 140 would compares each difference of the gray levels with a corresponding threshold value, followed by judging whether the image displayed by the display panel 160 is a static image or a dynamic image according to the proportion that the summation of the differences of the gray levels of the cases where each of the differences of the gray levels is greater than the corresponding threshold value over all the summation of all the differences of the gray levels of all the cases. When the proportion is greater than a critical proportion, the image displayed by the display panel 160 is judged as a dynamic image; when the proportion is not greater than the critical proportion, the image displayed by the display panel 160 is judged as a static image.

It should be noted that the above-mentioned critical proportion and the threshold value are specified by the design engineer or the user according to the empirical rule or the experiment data, which is omitted to describe.

After the mode switch 140 has judged the image to be displayed by the display panel 160 is a static image or a dynamic image according to the variation, the displaying mode MODE for adjusting the luminance of the backlight panel 180 is accordingly set. When the image to be displayed by the display panel 160 is judged by the mode switch 140 as a static image, the displaying mode MODE is set as the static mode. When the image to be displayed by the display panel 160 is judged by the mode switch 140 as a dynamic image, the displaying mode MODE is set as the animated mode.

The mode switch 140 further transmits the displaying mode MODE to the backlight adjuster 170, and the backlight adjuster 170 accordingly adjusts the luminance of the backlight panel 180 according to the displaying mode MODE, wherein when the displaying mode MODE is animated mode, the backlight adjuster 170 accordingly adjusts down the luminance of the backlight panel 180 for saving electric power; when the displaying mode MODE is static mode, the backlight adjuster 170 accordingly adjusts up the luminance of the backlight panel 180 for making the display frame more clear.

It should be specifically noted that the scheme adopted by the present invention is that the backlight control apparatus 100 dynamically detects the image to be displayed by the display panel 160 and switches the luminance of the backlight panel 180 when the display frame of the display panel 160 has a larger variation. In this way, the switching operation of the backlight panel 180 is unlikely noticed by the user, which effectively reduces the flashing of the frames.

It should be also noted that the backlight adjuster 170 also receives a control signal come from the control register 121, which is intended to provide the user with an interface to adjust the luminance of the backlight panel 180 by using the host terminal 190. In this way, as the backlight adjuster 170 adjusts the luminance of the backlight panel 180 according to the displaying mode MODE, the luminance can be adjusted also according to a base formed by the luminance of the backlight panel 180 set by the above-mentioned user through the host terminal 190. For example, when the displaying mode MODE is the static mode, the luminance of the backlight panel 180 is the one set by the user; when the displaying mode MODE is the animated mode, the luminance of the backlight panel 180 is adjusted to the result of the luminance of the backlight panel 180 set by the user multiplied by a factor less than 1 (for example, 80%).

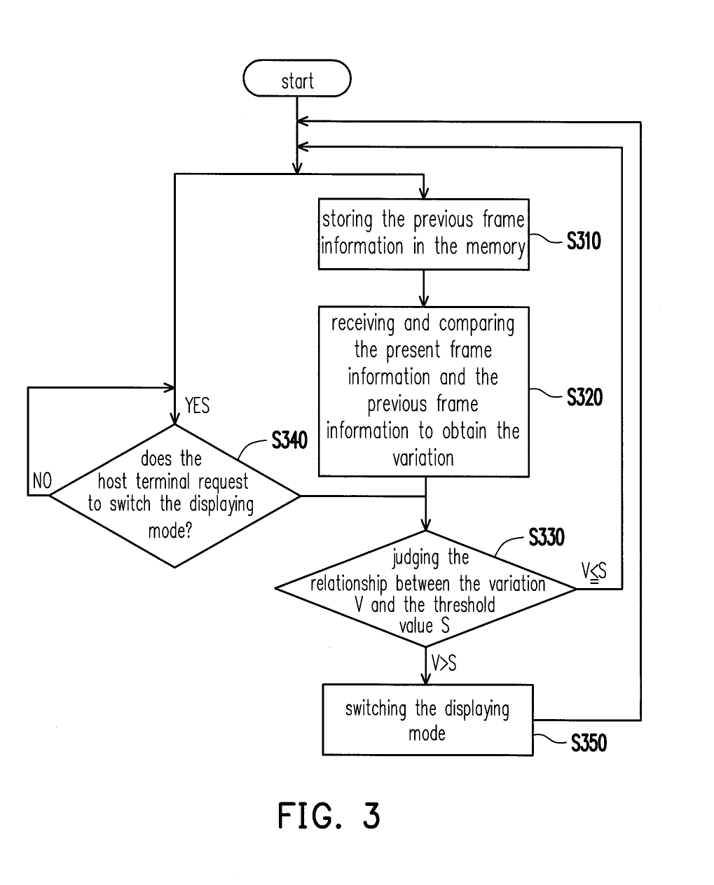

FIG. 3 is a flowchart of a backlight control method according to an embodiment of the present invention. Referring to FIG. 3, firstly, the previous frame information is stored in the memory (step S310), the present frame information is received and the received present frame information is compared with the previous frame information in the memory so as to obtain the variation between the two successive frame information (step S320). At the time, the present frame information can also be temporarily stored in the memory and then be read out when the present frame information needs to be compared with the previous frame information; or instead, the present frame information has no need to be temporarily stored in the memory at all, but is directly compared with the previous frame information read out from the memory.

After obtaining the variation, the relationship between the variation V and the threshold value S is judged (step S330), wherein when the variation V is greater than the threshold value S, the displaying mode is switched (step S350); otherwise, if it is judged that the variation V is not greater than the threshold value S, the displaying mode is not switched and the process goes back to execute step S310. On the other hand, the host terminal can also send out a request to switch the displaying mode so that the process enters step S340 where it is judged whether or not the host terminal asks switching the displaying mode. If the host terminal asks switching the displaying mode, the process goes to step S330 and finds out the time-point where the variation between the present frame information and the previous frame information is larger and the displaying mode is switched so as to meet the requirement of switching the displaying mode by the host terminal.

In summary, the present invention takes advantage of the variation of the image displayed by the display panel. If the variation is larger, the luminance of backlight panel is switched, which effectively reduces the flashing display frames resulted by switching the luminance of backlight panel. As a result, the present invention is advantageous in saving the power consumption and effectively advancing the display quality.

It will be apparent to those skilled in the art that the descriptions above are several preferred embodiments of the present invention only, which does not limit the implementing range of the present invention. Various modifications and variations can be made to the structure of the present invention without departing from the scope or spirit of the invention.

What is claimed is:

1. A backlight control apparatus, for controlling a luminance of a backlight panel, comprising:
an image analyzer, receiving a present frame information and a previous frame information and comparing the present frame information with the previous frame information to obtain a variation between the present frame information and the previous frame information; and
a mode switch, coupled to the image analyzer, receiving the variation and setting a displaying mode for adjusting the luminance of the backlight panel according to the variation.

2. The backlight control apparatus as claimed in claim 1, wherein the image analyzer obtains the variation according to the differences of gray levels of a plurality of pixels corresponding to a same display position between the present frame information and the previous frame information.

3. The backlight control apparatus as claimed in claim 1, wherein the mode switch compares the variation with a threshold value, when the variation is greater than the threshold value, the mode switch sets the displaying mode as an animated mode; when the variation is not greater than the threshold value, the mode switch sets the displaying mode as a static mode.

4. The backlight control apparatus as claimed in claim 3, wherein when the displaying mode is the animated mode, the luminance of the backlight panel is accordingly adjusted down; when the displaying mode is the static mode, the luminance of backlight panel is adjusted up.

5. The backlight control apparatus as claimed in claim 1, further comprising:
a memory, coupled to the image analyzer for receiving and storing the previous frame information.

6. A backlight control method, for controlling a luminance of a backlight panel and comprising:
providing an image analyzer for receiving a present frame information and a previous frame information, and comparing the present frame information with the last frame information to obtain a variation between the present frame information and the previous frame information; and
providing a mode switch for setting a displaying mode for adjusting the luminance of the backlight panel according to the variation.

7. The backlight control method as claimed in claim 6, wherein the step “comparing the present frame information with the previous frame information to obtain a variation between the present frame information and the previous frame information” comprises:
obtaining the variation according to the differences of gray levels of a plurality of pixels corresponding to a same display position between the present frame information and the previous frame information.

8. The backlight control method as claimed in claim 6, wherein the step “setting a displaying mode for adjusting the luminance of the backlight panel according to the variation” comprises:
comparing the variation with a threshold value;
setting the displaying mode as an animated mode when the variation is greater than the threshold value; and
setting the displaying mode as a static mode when the variation is not greater than the threshold value.

9. The backlight control method as claimed in claim 8, wherein when the displaying mode is the animated mode, the luminance of the backlight panel is adjusted down; when the displaying mode is the static mode, the luminance of the backlight panel is adjusted up

10. The backlight control method as claimed in claim 6, further comprising:
storing the previous frame information in a memory.
